(19) United States
(12) Patent Application Publication
(10) Pub. No.: US 2006/0271813 A1
(43) Pub. Date: Nov. 30, 2006

(54) SYSTEMS AND METHODS FOR MESSAGE HANDLING AMONG REDUNANT APPLICATION SERVERS

(76) Inventors: David Horton, Marlborough, MA (US); David Duda, Marlborough, MA (US)

Correspondence Address: CHOATE, HALL & STEWART LLP, TWO INTERNATIONAL PLACE, BOSTON, MA, 02110, US

(21) Appl. No.: 11/420,604

(22) Filed: May 26, 2006

Related U.S. Application Data
(60) Provisional application No. 60/684,893, filed on May 26, 2005.

(51) Int. Cl. G06F 11/00

(52) U.S. Cl. 714/4

(57) ABSTRACT

Systems and methods for messaging handling among redundant application servers are described. A method of providing application synchronization among a plurality of servers in an VoIP network environment includes pausing execution of an application on a standby server when the standby server encounters a checkpoint in the application and receiving a first message indicating that an active server reached the same checkpoint in a copy of the application executing on the active server. The method also includes transmitting, from the standby server, a second message to the active server indicating that the standby server received the first message and resuming execution of the application on the standby server.

### FIELD OF THE INVENTION

This application relates generally to telecommunications. More particularly, the application relates to a fault tolerant Voice-over-Internet Protocol (VoIP) architecture.

### BACKGROUND OF THE INVENTION

One of the current trends in telecommunications is the adoption of Voice-over-Internet Protocol (VoIP), which is a technology wherein voice traffic is transmitted over data, or packet-based, networks. Also commonly known in the telecommunications industry as “next generation networks”, these VoIP networks represent a significant change from legacy networks in which voice was transmitted over dedicated circuits and controlled using proprietary and expensive hardware-based switching and service elements. These legacy solutions were refined over many years, and have provided a highly available telecommunications infrastructure that has become broadly deployed throughout the world.

However, one area where the newer technology (VoIP) has not traditionally matched the capability of the older technology is the reliability of the end-to-end system and services. Legacy, circuit-switched voice networks can more reasonably lay claim to achieving 99.999% uptime when compared to current VoIP networks. A major challenge, therefore, for those deploying VoIP networks is providing the level of reliability to which the customer base is historically accustomed to. Current high availability solutions for VoIP services can be classified into two groupings: hardware-based solutions and software-based solutions.

Hardware-based solutions typically use proprietary and expensive dedicated hardware platforms to provide fault tolerant solutions. These are closed, single-chassis systems which include redundant hardware components and proprietary operating systems to provide application-level fault tolerance for VoIP services.

Software-based solutions typically operate on commercial hardware and software platforms but provide a lower level of fault tolerance. Typically, these solutions do not provide application-level fault tolerance; that is to say, when a fault occurs on one machine the other machine takes over service processing and new VoIP calls are handled normally, but VoIP calls in progress at the time of the failure experience some form of service loss or degradation. Put another way, the application state information pertaining to the state of an existing VoIP call at the time of the failure on the faulting machine may be lost or incomplete, which prevents the other machine from providing a seamless service experience to the end user of the service after it becomes active.

### SUMMARY OF THE INVENTION

One aspect of the invention features a system and method for providing application-level fault tolerance to services running in a VoIP network, utilizing low-cost commercial hardware and software platforms. The foregoing may provide fault tolerance at the application level so that highly complex VoIP services can survive the failure of hardware or software components without any impact to the end users of the service. It may be desirable to utilize techniques which can be deployed at a lower cost than existing hardware-based high availability solutions. It may also be desirable that the techniques utilize commercial hardware, and can be easily distributed geographically. The techniques may also provide application-level fault tolerance, allowing highly complex and stateful VoIP applications to continue to execute without a loss or degradation of service to end users during and after the failure of a hardware or software component.

In one aspect, the invention features a method of providing application synchronization among a plurality of servers in an VoIP network environment. The method includes pausing execution of an application on a standby server when the standby server encounters a checkpoint in the application and receiving a first message indicating that an active server reached the same checkpoint in a copy of the application executing on the active server. The method also includes transmitting, from the standby server, a second message to the active server indicating that the standby server received the first message and resuming execution of the application on the standby server

In various embodiments, the method includes immediately resuming immediately after receiving the first message, resuming a predetermined time after transmission of the second message, and resuming after a predetermined time if the standby server does not receive the first message. In other embodiments, the method includes transmitting via a direct connection between the active server and the standby server, receiving via a direct connection between the active server and the standby server.

In another aspect, the invention features a computer readable medium having executable instructions thereon to provide application synchronization among a plurality of servers in an VoIP network environment. The computer readable medium includes instructions to pause execution of an application on a standby server when the standby server encounters a checkpoint in the application and receive a first message indicating that an active server reached the same checkpoint in a copy of the application executing on the active server. The computer readable medium also includes instructions to transmit, from the standby server, a second message to the active server indicating that the standby server received the first message and resume execution of the application on the standby server.

In yet another aspect, the invention features a computing device that provides application synchronization among a plurality of servers in a VoIP network environment. The computing device includes a processor for executing computer readable instructions and a memory element that stores computer readable instructions. Executing the instructions causes the computing device to pause execution of an application on a standby server when the standby server encounters a checkpoint in the application and receive a first message indicating that an active server reached the same checkpoint in a copy of the application executing on the active server. Executing the instructions also cause the computing device to transmit, from the standby server, a second message to the active server indicating that the standby server received the first message and resume execution of the application on the standby server.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 depicts an embodiment of VoIP network environment;

FIG. 2 depicts a block diagram of an embodiment of a server of the VoIP environment of FIG. 1;

FIG. 3 depicts a block diagram of an embodiment of a pair of servers of the VoIP environment;

FIG. 4 is a flow diagram depicting an embodiment of a method for providing application layer fault tolerance in a VoIP environment;

FIG. 5 is a flow diagram depicting an embodiment of a method for providing application layer fault tolerance in a VoIP environment;

FIG. 6 depicts a block diagram of another embodiment of a server for use in the VoIP environment;

FIG. 7 depicts a flow diagram of an embodiment of a method of accounting for out-of-order messages in VoIP environment; and

FIG. 8 depicts a flow diagram of an embodiment of a method for providing application level fault tolerance using application checkpoints.

### DETAILED DESCRIPTION

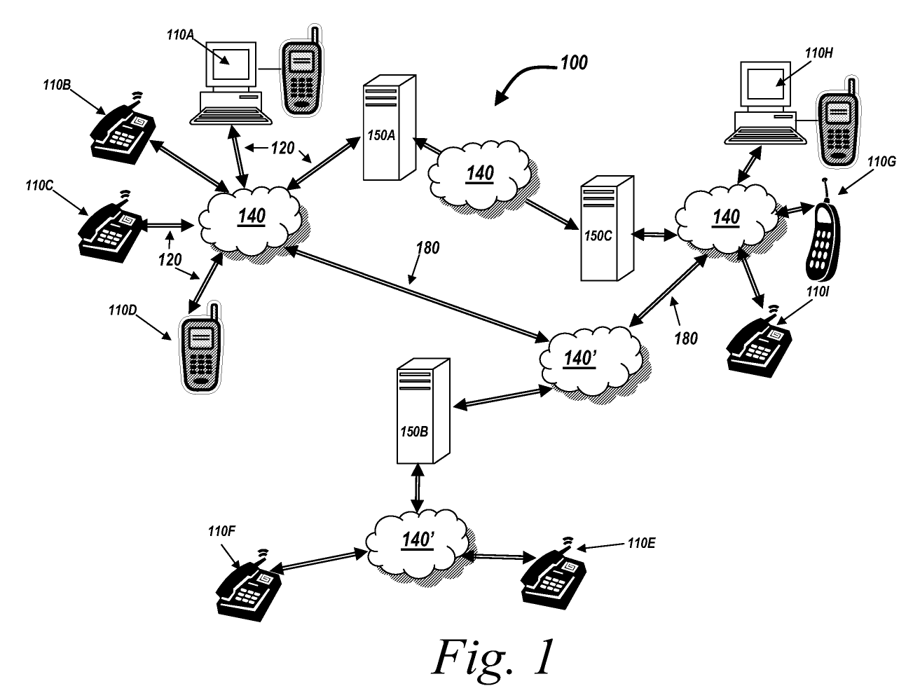

With reference to FIG. 1, a VoIP environment 100, includes one or more communications devices 110A, 110B, . . . , 110I (hereinafter a communication device or plurality of communication devices is generally referred to as communication device 110) in communication with one or more other communication devices 110 via one or more communications networks 140. The VoIP environment also includes one or more server computing devices 150A, 150B, 150C (hereinafter each server computing device or plurality of computing devices is generally referred to as server 150). Although FIG. 1, depicts an embodiment of a VoIP environment 100 having multiple communication devices 110 and three servers 150, any number of communication devices 110 and servers 150 may be provided.

Communications devices 110 and servers 150 can communicate with one another via networks 140, which can be a local-area network (LAN), a metropolitan-area network (MAN), or a wide area network (WAN) such as the Internet or the World Wide Web. Communication devices 110 connect to the network 140 via communications link 120 using any one of a variety of connections including, but not limited to, LAN or WAN links (e.g., T1, T3, 56 kb, X.25), broadband connections (ISDN, Frame Relay, ATM), and wireless connections. The connections can be established using a variety of communication protocols (e.g., SIP, UDP, TCP/IP, IPX, SPX, NetBIOS, and direct asynchronous connections).

In other embodiments, the communication devices 110 and servers 150 communicate through a second network 140′ using communication link 180 that connects network 140 to the second network 140′. The protocols used to communicate through communications link 180 can include any variety of protocols used for long haul or short transmission. For example, RTP, TCP/IP, IPX, SPX, NetBIOS, NetBEUI, SONET and SDH protocols or any type and form of transport control protocol may also be used, such as a modified transport control protocol, for example a Transaction TCP (T/TCP), TCP with selection acknowledgements (TCPSACK), TCP with large windows (TCP-LW), a congestion prediction protocol such as the TCP-Vegas protocol, and a TCP spoofing protocol. In other embodiments, any type and form of user datagram protocol (UDP), such as UDP over IP, may be used. The combination of the networks 140, 140′ can be conceptually thought of as the Internet. As used herein, Internet refers to the electronic communications network that connects computer networks and organizational computer facilities around the world.

The communications device 110 can be any telephone, SIP phone, personal computer, server, Windows-based terminal, network computer, wireless device, information appliance, RISC Power PC, X-device, workstation, minicomputer, personal digital assistant (PDA), main frame computer, cellular telephone or other computing device that provides sufficient faculties to execute software that allows an end-user of the communications device 110 to participate in VoIP telephone calling sessions. The communications device includes software capable of communicating with the servers 150 and other communications devices 110 using the Session Initiation Protocol (SIP).

The server 150 can be any type of computing device that is capable of communication with one or more communication devices 110 or one or more servers 150. For example, the server 150 can be a traditional server computing device, a web server, an application server, a DNS server, or other type of server. In addition, the server 150 can be any of the computing devices that are listed as communication devices 110. In addition, the server 150 includes software capable of communicating with the communication devices 110 and the other servers 150 using the Session Initiation Protocol (SIP).

The communication devices 110 can communicate directly with each other in a peer-to-peer fashion or through a server 150. For example, in some embodiments a communication server 150 facilitates communications among the communication devices 110. The server 150 may provide a secure channel using any number of encryption schemes to provide secure communications among the communication devices 110.

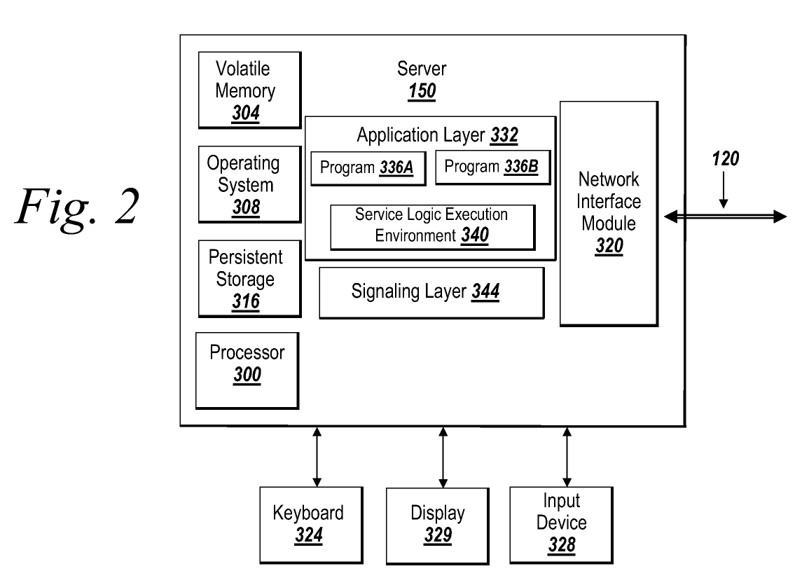

There are several different names that are used to describe the elements in a VoIP network that execute service logic: feature server, application server, proxy server, session controller, application switch, etc. However, regardless of the terminology used, they all share some common architectural elements, as pictured in the example representation of FIG. 2. It should be understood that other embodiments of the server 150 can include any combination of the following elements or include other elements not explicitly listed. In one embodiment, the server 150 includes a processor 300, a volatile memory 304, an operating system 308, persistent storage memory 316, a network interface 320, a keyboard 324, at least one input device 328 (e.g., a mouse, trackball, space ball, bar code reader, scanner, light pen and tablet, stylus, and any other input device), and a display 329. In one embodiment, the server operates in a “headless” configuration.

The server operating system can include, but is a not limited to, WINDOWS 3.x, WINDOWS 95, WINDOWS 98, WINDOWS NT 3.51, WINDOWS NT 4.0, WINDOWS 2000, WINDOWS XP, WINDOWS VISTA, WINDOWS CE, MAC/OS, JAVA, PALM OS, SYMBIAN OS, LINSPIRE, LINUX, SMARTPHONE OS, the various forms of UNIX, WINDOWS 2000 SERVER, WINDOWS SERVER 2003, WINDOWS 2000 ADVANCED SERVER, WINDOWS NT SERVER, WINDOWS NT SERVER ENTERPRISE EDITION, MACINTOSH OS X SERVER, UNIX, SOLARIS, and the like. In addition, the operating system 308 can run on a virtualized computing machine implemented in software using virtualization software such as VMWARE.

The volatile memory 304 and persistent storage 316, alone or in combination, store executable computer code (i.e., software) that establishes, maintains, and terminates VoIP telephone calls between communication devices 110. In one embodiment, the functionality is provided when the processor 300 executes application layer 332 software, signaling layer 344 software. As such, the communication devices 110 transmit messages and possibly media (e.g., audio) via the network interface module 320.

In one embodiment, the signaling layer 344, which is also referred to as a signaling “stack”, is responsible for constructing, maintaining, modifying, and terminating VoIP sessions, during which media (e.g., audio) is exchanged among the communication devices 110 and the server 150. In one embodiment, the signaling layer 344 uses one or more VoIP signaling protocols, such as Session Invitation Protocol (SIP) and H.323 to provide communications among the servers 150 and the communication devices 110. The signaling layer 344 interfaces with the network 140 via the network interface module 320 to transmit messages over the network 140 using one of the above-described protocols (e.g., internet protocol (IP)).

In one embodiment, the processor 300 in cooperation with the volatile memory 304 operates on instructions stored therein. In one embodiment, the application layer 332 includes programs 332 and a service logic execution environment 340. The service logic execution environment 340 is where the VoIP service logic specific to a particular service executes. The service logic execution environment 340 does not interface directly with the network 140, but communicates with the signaling layer 344 to accomplish the signaling and media flows needed to provide the service.

In one embodiment, one or more programs 336A, 336B describe the service logic that comprises a specific VoIP service. The program 336A is processed within the service logic execution environment 340 in order to provide that service in the VoIP network environment 100. Put another way, the program 336 is the set of instructions that is executed within the service logic execution environment 340. A single service logic execution environment 340 may execute more than one stored programs 336 concurrently. As used herein, the terms “application” or “service” are used interchangeably with “stored program”.

The relationship between the application layer 332 and the signaling layer 344 is a master-slave relationship. That is, the application layer 332 decides what sessions need to be created, modified, or terminated among the communication devices 110 and the servers 150 and the signaling layer 344 carries out these instructions.

The two layers also have a relationship in terms of how service logic is initiated. Generally, service logic is initiated by the arrival of a new call (which can more generally be described as a “session invitation” from a communication device 110), or other network event that is detected by the signaling layer 344. As used herein, an event refers to a message, response, or packet that causes a change in some level of the VoIP environment. Examples of events include, but are not limited to, call initiations, call termination, conference calling, ringing, off-hook, on-hook, and the like. In response, the signaling layer 344 forwards a description of the event to the application layer 332, which causes the execution of a specific VoIP program 336.

Conceptually, the application layer 332 is the “brains” of the VoIP session. As such, the application layer 332 is where application state information for a complex VoIP services is kept. In one embodiment, a VoIP application 336 (e.g., an audio conference bridge and the like), of the application layer 332 contains state information such as the identification of the caller for billing purposes, whether the caller is currently navigating an Interactive Voice Response (IVR) menu, and if so which specific menu, and whether the caller is a moderator of the call or just a participant. In one embodiment, in the case of a hardware or software component failure, this state information is preserved and communicated to another server as described below to achieve fault tolerance at the application level. As a result, the appropriate delivery of the service to the end-users is provided.

During operation, the signaling layer 344 also maintains state information, but it is VoIP session state information, as opposed to application state information. For instance, the signaling layer 344 has state information such as which sessions are currently in progress, whether any scheduled session maintenance activities are necessary to maintain the session (e.g., keep alive messages between endpoints), and the network addresses of the local and remote communication device 110 or server 150 for signaling and media flows. This information is also preserved and communicated to another server, as described below, in the case of a component failure to achieve application-level fault tolerance.

The signaling layer 344 receives input from both the network 140 via the network interface module 320 and the application layer 332. From the network 140 the signaling layer 344 receives events that are forwarded to the application layer 332 for processing. In response to the events, the application layer 332 forwards messages to the signaling layer 344 that are in turn translated into network requests by the signaling layer 344. As shown, there exists a cause-and-effect relationship between the application layer 332 and the signaling layer 344. A command from the application layer 332 is translated into a network request that in turn results in a network event that is a response to that request. Certain network events will therefore only be expected to be received after a corresponding network request has been made. In other words, there are a set of rules that can be codified describing the allowable order of events in the signaling layer 334, given a specific signaling protocol.

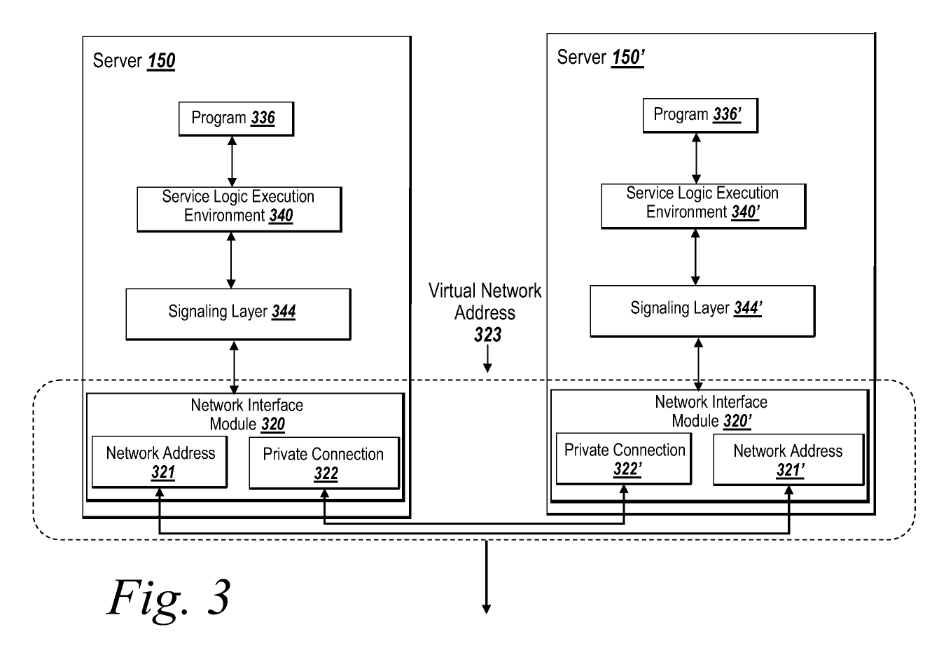

With reference to FIG. 3, one embodiment of providing a system that is resilient to hardware and software faults includes two instances of the hardware and software for providing VoIP communications that each operate on a different server 150, 150′. The fundamental concept is that one of the paired servers 150, is active at any time (referred to as active server 150), and the other provides a replica of the hardware and software environment that is operating in a standby mode (referred to as standby server 150′). In such a system, it is possible to switch from one server 150 to the other server 150′ when either a hardware or software failure occurs at time, without any loss of service to end-users of the services. The two servers 150, 150′ are thus paired in an active-standby relationship, as depicted in FIG. 3.

Each server 150, 150′ includes a network interface module 320, 320′ that provides one or more physical connections to the network and an associated IP network address 321, 321′ by which other network elements can send packets to that interface. Each server 150, 150′ also includes one or more private connections 322, 332′over the active server 150 exchanges status messages with the standby server 150′.

In one embodiment no private connections 322, 322′ are provided. In such an embodiment, the status messages are exchanged, for example, between the active server 150 and the standby server 150′ using the network addresses 321, 321′of the network interface modules 320, 320′. In one embodiment, a crossover Ethernet cable connects the active server 150 to the standby server 150. In one embodiment, the active server 150 and the standby server 150′ are located on the same network 140. In another embodiment, the active server 150 and the standby server 150′ are located on separate networks 140. As such, the two servers 150, 150′ may be co-located in the same geographic site, or they may be installed in different geographic sites.

In one embodiment, the active server 150 and the standby server 150′ share a “virtual” address 323. As used herein, virtual address 323 refers to a single IP address that, at any point in time, is used by other network devices and servers to reach the active server 150. Thought of another way, the virtual address is assignable and switchable between the active server 150 and the standby server 150′.

Various known means of detecting hardware or software failures on the active server 150 are used to begin a “failover”, or switch, to the standby server 150′. Once complete, the standby server 150′ becomes the active server 150 and continues the application and session processing without impact to the end-users of the communications devices 110. When such a failover occurs, the virtual address 323 is re-assigned to the newly-active server (i.e., the original standby server 150′), such that all network elements now direct their packets to that server. During the failover, the application and session state information existent at the time of the failure on the on the failed server becomes available on the other (newly active) server.

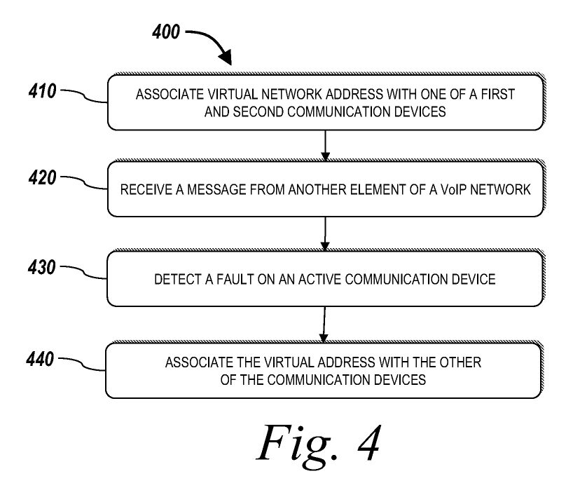

With reference to FIG. 4, a method 400 for providing fault tolerance in a VoIP environment is shown and described. The method 400 includes associating (STEP 410) a virtual network address with one of a first communication device and a second communication device 110. Each of the first and second communication devices 110 is coupled to a VoIP network and is in communication with each other. The virtual network address is associated with an active one of the first and the second communication devices 110. The method also includes receiving (STEP 420) a message from another element coupled to the VoIP network at the communication device 100 associated with the virtual address and detecting (STEP 430) a fault on the active communication device. The detection occurs when the active communication device 110 is at an execution point of an application that is executing on the active communication device 110. The application provides a services. Typically, the service is a VoIP service. The method 400 also includes associating (STEP 440) the virtual address with the other of the communication devices in response to the detection of the fault. The other of communication devices 110 continues to provide the service from the same execution point. Said another way, the application 336′ on the standby 150′ resumes execution of the application 336′ at the same place as the where the active server 150 stopped. This could be the same instruction or the next instruction of the application 336.

In one embodiment, the virtual network address is associated (STEP 410) by a network technician during the installation of the server 150. In another embodiment, management software (not shown) executing on another computing device of the network 140 provides a means for a network administrator to associate the virtual address with one of the servers 150. Which ever server 150 is associated with the virtual address becomes the active server 150 and begins processing and responding to VoIP network events. In one embodiment, the virtual IP address is included in a configuration file that is deployed on both servers 150. The configuration file includes information that defines the virtual IP address, which of the servers 150 is initially designated as the active server 150, as well as other information.

Other elements and communication devices 110 (not shown) of the network 140 transmit messages to the active server 150. The active server 150 receives (STEP 420) the messages. In response, active server 150 processes the messages and generates a response to each of the received messages.

In some instances, before, during, or after the processing of a message, a fault can occur at the active server 150. In one embodiment, a software fault occurs. For example, an operating system failure can require a system reboot. Other examples of software faults include, but are not limited too, an application failure, a protocol failure, a thread failure, memory exhaustion, disk space exhaustion, and the like. In another embodiment, a hardware fault occurs. Examples of hardware faults include, but are not limited to, a power supply failure, a memory failure, a processor failure, network card failure, and the like. In one embodiment, if the fault is detected during the execution of the program 336, the point of execution in the program is noted. In another embodiment, the point of execution of the program 336 is not noted.

After detecting a fault at the active server 150, the virtual address is associated (STEP 440) with the other server 150′. That is, the other server 150′ begins directly receiving messages from the network 140. The application 336′ that is executing on the other server 150′ begins executing at the execution point where the fault was detected on the active server 150. In essence, the other server 150′ begins executing and responding to messages at the place in the application 336′ where the fault occurred on the active server 150.

In order to provide fault tolerance and redundancy at the application layer level, various techniques and methods for replicating state information can be used. In general, the standby server 150′executes the same stored programs 336′ and receives a similar stream of events as the active server 150. As a result, the standby server 150′ over time constructs the same state information as the active server 150. At both the application layer and the signaling layer, the state information at any point in time is a function of the event stream received and the behavior that is specified in response to those events. Formally, this may be represented as follows: Sn=f(Sn−1, E, B); that is, the state information at period n (Sn) is a function of the state information of the previous period (Sn−1), along with the events (E) received this period, and the behavior (B) that is specified in response to those events while in the current state.

At the application level, it is the application service logic (i.e., the stored program 336) that performs the specification of the behavior required; at the signaling level, is the protocol specification (e.g. SIP or H.323) that forms the specification of the behavior required. Thus, if the standby server 150′ executes the same applications 336′ and protocols as the active server 150, and receives the same stream of events, the standby server 150′ may construct the same application state and signaling state information as the active server 150.

This technique may be characterized as one whereby “scaffolding” is built around the standby server 150′, wherein the same inputs are provided to the executing stored program 336′ as are delivered on the active server 150 without, however, allowing the standby server 150′ to interact with the network 140 or other external elements. When a fault and subsequent failover occurs, the “scaffolding” is removed and the newly-active server continues executing as before; however, now the server 150 begins sending and receiving packets to other elements on the network 140. To those external network elements, and the end-users beyond them, the transition is seamless and uninterrupted, with no loss of any facility or function that was previously being provided by the application 336, nor any loss of “memory” about the state of the end-users, their preferences, or the network devices which are interacting.

In some embodiments, it may be difficult to produce a perfectly equivalent event stream at the standby sever 150. Some reasons for this include, natural variances in the delivery times of packets on an IP network as well as variances in the timing of instructions between two different (even though similarly configured) servers 150. These reasons result in a situation where the standby server 150′ receives a “similar” stream of events as the active server 150. A first stream of events as described herein may be characterized as a similar stream of events with respect to a second stream of events in that both contain the same events. However, the order of events as well as their inter-arrival times may differ between the two streams being compared.

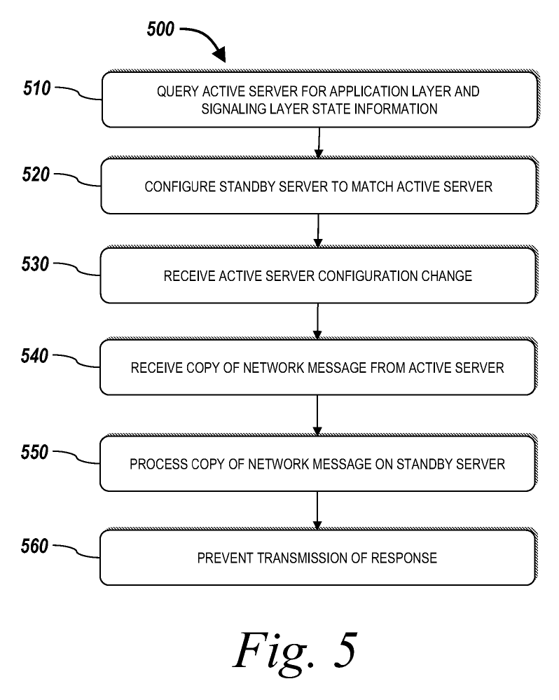

With reference to FIG. 5, a method 500 by which a similar stream of events can be processed in a way that result in the derivation of an equivalent set of application and signaling state information on the standby server 150′ is shown and described. Additionally, the method 500 describes processing the event stream in such a way so as to produce a replica of the application and signaling state information existent on the active server 150. This state information can be derived from the event stream on the standby server 150′, even when the two event streams are allowed to differ in the order and timing of events. The method 500 includes querying (STEP 510) the active server 150 for the application layer 332 and signaling layer 344 state information, configuring (STEP 520) the standby server 150′ to replicate the configuration of the active server 150, and receiving (STEP 530) configuration changes from the active server 150, if any are made to the active server 150. The method also includes receiving (STEP 540), at the standby server 150′, a copy of any network messages received by the active server 150, processing (STEP 550) the copy of the received network messages, and preventing (STEP 560) transmission of a response to the processed message.

Upon initialization, the standby server 150′ queries (STEP 510) the active server 150 for the current application configuration; e.g., which stored programs are running, and how many VoIP sessions each stored program is configured to support. In one embodiment, the query is transmitted via the private connections 322, 322′. In another embodiment, the query is transmitted using the network address 321, 321′ of the network interface module 320, 320′.

The standby server 150′ receives the state information from the active server 150 and configures (STEP 520) itself to be a replica of the active server 150. In one embodiment, the standby server 150′ starts an equivalent configuration of applications 336. In another embodiment, the standby server 150′ starts a sub-set of the applications 336 of the active server 150. The sub-set of application can include those deemed critical.

If a change is made to the application configuration on the active server (e.g., an application is stopped or a new application is started, via an element manager console (not shown)), the standby server receives (STEP 530) a change notification. In one embodiment, the active server automatically transmits change notifications to the standby server 150′. In another embodiment, the standby server 150′ periodically queries the active server 150 for any configuration changes. If there are changes, the configuration change is replicated on the standby server 150′.

During operation, the active server receives messages (e.g., a signaling message) at the active server 150 from the network 140. In response, a copy of the message is sent to the standby server 150′. The standby server 150′ receives (STEP 540) the copy of the messages from the active server 150. In one embodiment, the signaling stack 344′ on the standby server 150′ receives the messages via the private connection 322, 322′. In this way, the standby server 150′ receives a copy of every signaling message that the active server 150 receives. Once received, both the active server 150′ and the standby server 150′ signaling stacks 344, 344′ forward the messages to the application layers 322, 322′ on the respective servers.

After receiving the messages, the application layer processes (STEP 550) the signaling messages, along with other events, and may generate a signaling request. In one embodiment, the request is passed down to the signaling stack 344.

At the standby server 150′ the signaling stack processes the request but prevents (STEP 560) transmission of a network message. In one embodiment, the network message resulting from the processed signaling is dropped by the standby server 150′. In another embodiment, the network message is transmitted to a “dummy” network address. In yet another embodiment, the network message is placed in a queue for deletion by the standby server 150. It should be understood that other methods can be employed to prevent transmission of a network message from the standby server 150′.

Also, the service logic execution environment 340 of the active server 150 receives other inputs in addition to network messages. These inputs are also copied and forwarded to the service logic execution environment 340′ of the standby server 150′. Once received, these inputs are provided to the programs 336 executing on the standby server 150′. These other inputs may be characterized as state information or data and may include, for example, a value produced by another application used in connection with performing processing for a service by the service logic execution environment. Another example of an input is a message from an external database that includes information related subscriber (i.e., end-user) information updates.

As previously stated, since the active server 150′ is receiving messages and responding, in some case, with network messages of its own, it is not possible to guarantee that the standby server 150′ will receive the exact same event stream as the active server 150, in terms of order and inter-arrival times. Given this situation, at least two conditions can result that can affect fault tolerance for VoIP applications. One potentially dangerous situation results from receiving messages out of order at the standby server 150′ when compared to the order in which the messages are received at the active server 150. Another potentially dangerous situation results when the messages are received in the same order, but with significant timing differences between when they are received at the active server 150 and the standby server 150′. Certain features can be provided to account for these situations so as to maintain fault tolerance at the application layer 332 and the signaling layer 344.

There are at least two types of messages that may be received out-of-order by the standby server 150′. The first type of messages is network events and signaling messages, such as those that may be processed by the signaling layer 344′. The second type of message is state information, which may be processed by the service logic execution environment 340′.

In connection with the first type of messages, many VoIP signaling sequences or network events consist of a request that is sent by one network element to another, followed by a response traveling in the opposite direction. The following sequence illustrates how a message can be received out of sequence at the standby server 150′.

The stored program 336 executing on the active server 150 causes a signaling request to be sent to the signaling layer 344. The standby server 150′ executing the same program 336′ receives a copy the message from the active server 150. In response, the copy of the message is forwarded to the signaling stack 344′ of the standby server 150′. As such, the standby server 150′ receives the same message at close to the same instant, but not precisely the same instant, as the active server 150.

The signaling stack 344 of the active server 150 receives the message from the program 336 and sends the signaling request out on the network 140. This can occur before the signaling stack 344′ of the standby server 150′ receives the copy of the message from the active server 150. The signaling stack 344 of the active server 150 receives a corresponding response from the network 140 and forwards a copy of the response to the signaling stack 344′ of the standby server 344′. In such as scenario, the signaling stack 344′ of the standby server 150′ has received a response for a request that the standby server 150′ has not yet sent.

The above scenario illustrates one example where the order of events experienced by the standby server 150′ differs from that experienced by the active server 150′. The signaling stack 344 on the online server 150 experiences the following sequence of events: a) receive a request from the application layer 332; b) send a request to the network 140; and c) receive a response for the request from the network 140. On the other hand, the sequence of events for the signaling stack 344 on the standby server 150′ is: a) receive an unknown response from network 140 (i.e., the response can not be matched to any previous request); b) receive a request from the application layer 332′; and c) send the request to the network.

If not accounted for, this different sequence of events can cause a different application execution path to be taken on the standby server 150′ when compared to the active server 150. This divergence causes the application layer state information and signaling layer state information to fall out of synchronization between the active server 150 and the standby server 150′. If the active server 150 fails or faults, the divergent state information can cause a noticeable service impact to the end user, for example dropping an call that is in progress. Said another way, unless accounted for the out of order message prevent the achievement of application-level fault tolerance.

It may also be necessary to handle out-of-order at the service logic execution environment. For example, a piece of state information may be received by the service logic execution environment 340′ of the standby server 150′. The standby server 150′ may be waiting for this information in connection with a current operation or processing being performed. If so, the standby server 150′ processes the received state information. Otherwise, the state information received is unexpected (i.e., the standby server 150′ does not currently use the state information in its processing)

It is possible that the messages are received in the same order, but there can be timing differences between when the messages are received by each server 150. Consider a scenario where an application 336 of the active server 150, at a certain point in time, begins waiting for a network message. An application 336 that is waiting for a network message handles a receive message differently than if the a message is received before the application 336 begins waiting for the message.

If the active server 150 and the standby server 150′ are executing with slight timing differences, it is possible that the active server 150 will reach the point in the application 336 where it begins waiting for the network message slightly before the application 336′ on the standby server 150′. When the signaling stack 344 on the active server 150 receives the message from the network 140, a copy is sent to the signaling stack on the standby server 150′, which forwards it up to the application layer 332′ of the standby server 150′. Because the application 336′ on the standby server 150′ is not yet waiting for the message, it is either discarded or handled differently than on the active server 150. This situation causes the execution paths of the active server 150 and the standby server 150′ to diverge thus destroying application-level fault tolerance.

As shown, the naturally-occurring variances in server instruction processing times and network transmission times prevent the ability to guarantee an exactly equivalent event stream on the active server 150 and the standby server 150′. As such, the following methods provide for processing two similar event streams on the each of the active server 150 and standby server 150′ in such a way that the same state information is derived from the message stream. The techniques that may be utilized include, but are not limited to, application instruction check-pointing and queuing out of order events.

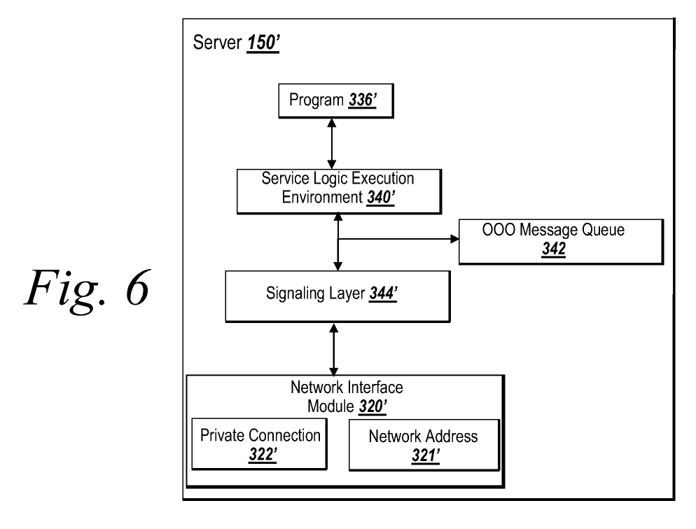

With reference to FIG. 6 an embodiment of a standby server 150′ configured for handling out-of-order messages is shown and described. In this embodiment, the standby server 150′ includes an out-of-order (OOO) message queue 342. In one embodiment, the out-of-order message queue is a dedicated area of the volatile memory 304. In another embodiment, the out-of-order message queue 342 is a dedicated area of the persistent storage 316. Messages from the active server 150 are received and stored in the out-of-order message queue. In one embodiment, each received message is stored in the out-of-order message queue 342. In another embodiment, only certain messages are stored in the out-of-order message queue 342.

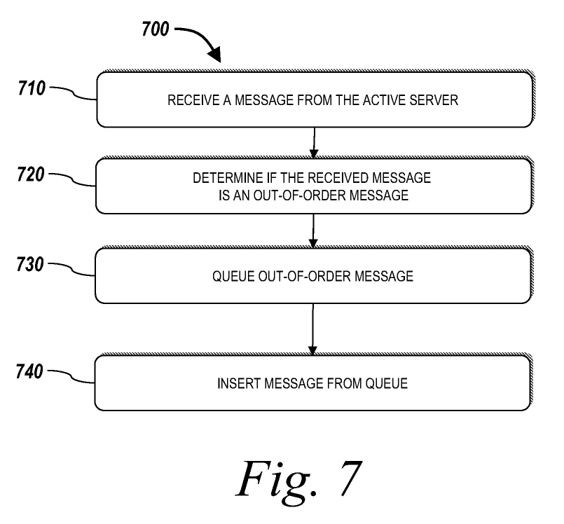

With reference to FIG. 7 a method 700 for queuing and processing out-of-order messages received by the standby server 105. In one embodiment, the method includes receiving (STEP 710) a message from the active server 150, determining (STEP 720) if the message is out-of-order, queuing (STEP 730) when the message is determined to be out of order, inserting (STEP 740) a message from the out-of-order message queue 342 as needed.

In one embodiment, the message is received (STEP 710) via the private connection 322′. In another embodiment, the standby server 150 receives (STEP 710) the message via the network address 321.

Various techniques can be used by the standby server 150 to determine (STEP 720) if the received message is an out-of-order message. For example, it can be assumed that all messages received from the active server 150 are out-of-order messages. In another embodiment, if the standby server 150′ is not “waiting” for a response or a message any received message is labeled as an out-of-order message.

Queuing (STEP 730) of out-of-order messages can be accomplished in various ways. For example, the out-of-order messages are stored in the volatile memory 304 of the standby server 150′. In another embodiment, the out-of-order messages are stored in a storage device (not shown) that is in communication with the standby server 150′. In yet another embodiment, the out-of-order messages are stored in the persistent storage 316 for the standby server 150′.

Various means and methods can be employed to insert (STEP 740) a specific message or response from the out-of-order message queue 740. In one embodiment, each time a response or message is needed the out-of-order message queue 342 is queried for the needed response and inserted into the event stream if the message is present. In another embodiment, when a message or response is needed by the service execution environment 340′ of the standby server 150′ may check newly received state information prior to checking for the state information in the out-of-order message queue 342.

To briefly summarize, messages can be received out of order by the standby server 150′. In order to derive the same state information on the standby server 150′ as on the active server 150, the out-of-order messages may be queued, rather than discarded, until it can be determined if the out-of-order messages relate to a future, not-yet-received, message. A response that is received in advance of the corresponding request is queued until a matching request is received. After processing the request, the queued response is reinserted into the event stream. If no matching request is received within a predetermined duration such as, for example, a duration of several seconds, then the unmatched response can be discarded.

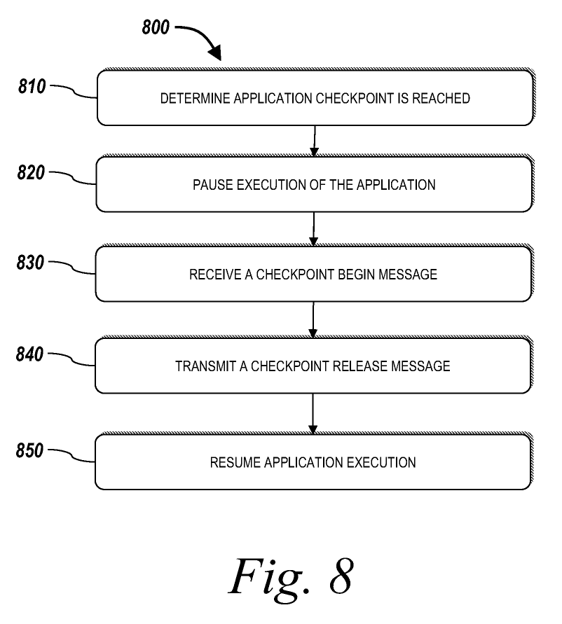

With reference to FIG. 8, a method 800 of providing application level fault tolerance using application checkpoints is shown and described. At a high level, the application 336 executing on the active server 150 and standby server 150′ attempt to synchronize their operation by periodically “checkpointing” with each other. Checkpointing, as used herein, refers to pausing the execution of an application 336. Checkpoints can be embodied as computer code that causes the pause of the execution of the application 336. In essence, the servers 150 are “loosely-coupled” with each other. In one embodiment, the method includes determining (STEP 810) that an application checkpoint is reached during the execution of an application 336, pausing (STEP 820) execution of the application 336, receiving (STEP 830) an checkpoint begin message from another server 150 executing the same application 336, transmitting (STEP 840) a checkpoint release message to the other server, and continuing (STEP 850) execution of the application 336 on the server 150. Generally speaking, the applications 336 on each of the servers 150 periodical confirm with each other that the applications are at the same point of execution of the application 336.

As each application instruction is executed, a determination (STEP 810) is made as to whether a checkpoint is required or present. In one embodiment, the application includes specific checkpoints. In another embodiment, every application instruction is a checkpoint. In yet another embodiment, only some of the application instructions are checkpoints.

When an application 336 encounters a checkpoint, the server 150 pauses (STEP 820) execution of the application 336. In one embodiment, the further processing of the application 336 is suspended indefinitely. In another embodiment, further processing of the application 336 is suspended for a predetermined time period. Assuming that the active serve 150 reaches the checkpoint first, the active server transmits a “checkpoint begin” message to the standby server 150′.

The standby server 150 receives (STEP 830) the checkpoint begin message. It should be understood that the checkpoint begin message can be received via either the private connection 322′ or network address 321′. In one embodiment, the checkpoint begin message is placed in the out-of-order message queue 342. When the application 336 executing on the standby server 150′ reaches the checkpoint, application on the standby server 150′ waits for a checkpoint begin message. In one embodiment, the application 336 queries the out-of-order message queue 342 for the checkpoint begin message.

After processing the checkpoint begin message, the standby server 150′ transmits a “checkpoint release” message the active server 150′. In one embodiment, the checkpoint release message is transmitted via the private connection 322′. In another embodiment, the checkpoint release message is transmitted via the network address 321′.

After transmitting the checkpoint release message, the standby server 150 resume execution of the application 336′. In one embodiment, the standby server 150′ waits a predetermined time period before resuming execution of the application 336′. In another embodiment, the standby server 150′ immediately resumes execution of the application 336′. When the active server 150 receives the checkpoint release message the active server 150 resume execution of the paused application.

To summarize, exchanging these “checkpoint” messages provides a means to closely synchronize the execution of the application 336 on the two servers 15. This reduces the likelihood and impact of timing differences. If either the active server 150 or the standby server 150′ waits in the checkpoint state without receiving a checkpoint begin message (i.e., the standby server 150′), or a checkpoint release message (i.e. the online server), then application execution continues and the paused instruction is executed. This prevents a total failure of one server 150 from propagating to the other server 150.

The previously described embodiments may be implemented as a method, apparatus or article of manufacture using programming and/or engineering techniques to produce software, firmware, hardware, or any combination thereof. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.), a file server providing access to the programs via a network transmission line, wireless transmission media, signals propagating through space, radio waves, infrared signals, etc. The article of manufacture includes hardware logic as well as software or programmable code embedded in a computer readable medium that is executed by a processor. Of course, those skilled in the art will recognize that many modifications may be made to this configuration without departing from the scope of the present invention.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A method of providing application synchronization among a plurality of servers in an VoIP network environment, the method comprising:
pausing execution of an application on a standby server when the standby server encounters a checkpoint in the application;
receiving a first message indicating that an active server reached the same checkpoint in a copy of the application executing on the active server;
transmitting, from the standby server, a second message to the active server indicating that the standby server received the first message; and
resuming execution of the application on the standby server.

2. The method of claim 1 wherein the resuming occurs immediately after receiving the first message.

3. The method of claim 1 wherein the resuming occurs a predetermined time after transmission of the second message.

4. The method of claim 1 wherein the resuming occurs after a predetermined time if the standby server does not receive the first message.

5. The method of claim 1 wherein the transmitting occurs via a direct connection between the active server and the standby server.

6. The method of claim 1 wherein the receiving occurs via a direct connection between the active server and the standby server.

7. The method of claim 1 wherein the application provides a VoIP service.

8. A computer readable medium having executable instructions thereon to provide application synchronization among a plurality of servers in an VoIP network environment, the computer readable medium comprising:
instructions to pause execution of an application on a standby server when the standby server encounters a checkpoint in the application;
instructions to receive a first message indicating that an active server reached the same checkpoint in a copy of the application executing on the active server;
instructions to transmit, from the standby server, a second message to the active server indicating that the standby server received the first message; and
instructions to resume execution of the application on the standby server.

9. The computer readable medium of claim 8 wherein the instructions to resume comprise instructions to resume execution immediately after receiving the first message.

10. The computer readable medium of claim 8 wherein the instructions to resume comprise instructions to resume execution a predetermined time after transmission of the second message.

11. The computer readable medium of claim 8 wherein the instructions to resume comprise instructions to resume execution after a predetermined time if the standby server does not receive the first message.

12. The computer readable medium of claim 8 wherein the instructions to transmit comprise instructions to transmit the second message via a direct connection between the active server and the standby server.

13. The computer readable medium of claim 8 wherein the instructions to receive comprise instructions to receive the first message via a direct connection between the active server and the standby server.

14. A computing device that provides application synchronization among a plurality of servers in an VoIP network environment, the computing device comprising:
a processor for executing computer readable instructions; and
a memory element that stores computer readable instructions that when executed by the processor cause the computing device to:
pause execution of an application on a standby server when the standby server encounters a checkpoint in the application;
receive a first message indicating that an active server reached the same checkpoint in a copy of the application executing on the active server;
transmit, from the standby server, a second message to the active server indicating that the standby server received the first message; and
resume execution of the application on the standby server.

15. The computing device of claim 14 wherein the memory element further stores instructions to resume execution immediately after receiving the first message.

16. The computing device of claim 14 wherein the memory element further stores instructions to resume execution a predetermined time after transmission of the second message.

17. The computing device of claim 14 wherein the memory element further stores instructions to resume execution after a predetermined time if the standby server does not receive the first message.

18. The computing device of claim 14 wherein the memory element further stores instructions to transmit the second message via a direct connection between the active server and the standby server.

19. The computing device of claim 14 wherein the memory element further stores instructions to receive the first message via a direct connection between the active server and the standby server.
